(19) United States
(12) Patent Application Publication
(10) Pub. No.: US 2021/0280967 A1
(43) Pub. Date: Sep. 9, 2021

(54) SMART LIGHTING APPARATUS

(71) Applicant: XIAMEN ECO LIGHTING CO. LTD., XIAMEN (CN)

(72) Inventors: Chihhsien WU, XIAMEN (CN); Minghui LI, XIAMEN (CN); Renhua ZOU, XIAMEN (CN); Pofeng PENG, XIAMEN (CN); Raymond CHEN, XIAMEN (CN)

(21) Appl. No.: 16/817,469

(22) Filed: Mar. 12, 2020

Related U.S. Application Data
(63) Continuation-in-part of application No. 16/810,193, filed on Mar. 5, 2020.

(51) Int. Cl. H01Q 1/44; H01Q 1/48; F21V 23/00; F21V 29/70; H05B 47/19

(52) U.S. Cl. CPC H01Q 1/44; H01Q 1/48; F21Y 2105/10; F21V 29/70; H05B 47/19; F21V 23/003

(57) ABSTRACT

A smart lighting apparatus has a metal cover, an antenna module, a wireless circuit, a cup body, a light source, and a driver. The metal cover has a central opening, a front and a back side. The antenna module has an antenna area on the metal ring and receives a wireless signal from the antenna area. The wireless circuit is electrically connected to the antenna module.

### RELATED APPLICATION

The present application is a continuation-in-part application of U.S. patent application Ser. No. 16/810,193.

### FIELD

The present invention is related to a smart lighting apparatus and more particularly related to a smart lighting apparatus with an antenna.

### BACKGROUND

Lighting or illumination is the deliberate use of light to achieve a practical or aesthetic effect. Lighting includes the use of both artificial light sources like lamps and light fixtures, as well as natural illumination by capturing daylight. Daylighting (using windows, skylights, or light shelves) is sometimes used as the main source of light during daytime in buildings. This can save energy in place of using artificial lighting, which represents a major component of energy consumption in buildings. Proper lighting can enhance task performance, improve the appearance of an area, or have positive psychological effects on occupants.

Indoor lighting is usually accomplished using light fixtures and is a key part of interior design. Lighting can also be an intrinsic component of landscape projects.

A light-emitting diode (LED) is a semiconductor light source that emits light when current flows through it. Electrons in the semiconductor recombine with electron holes, releasing energy in the form of photons. This effect is called electroluminescence. The color of the light (corresponding to the energy of the photons) is determined by the energy required for electrons to cross the band gap of the semiconductor. White light is obtained by using multiple semiconductors or a layer of light-emitting phosphor on the semiconductor device.

Appearing as practical electronic components in 1962, the earliest LEDs emitted low-intensity infrared light. Infrared LEDs are used in remote-control circuits, such as those used with a wide variety of consumer electronics. The first visible-light LEDs were of low intensity and limited to red. Modern LEDs are available across the visible, ultraviolet, and infrared wavelengths, with high light output.

Early LEDs were often used as indicator lamps, replacing small incandescent bulbs, and in seven-segment displays. Recent developments have produced white-light LEDs suitable for room lighting. LEDs have led to new displays and sensors, while their high switching rates are useful in advanced communications technology.

LEDs have many advantages over incandescent light sources, including lower energy consumption, longer lifetime, improved physical robustness, smaller size, and faster switching. Light-emitting diodes are used in applications as diverse as aviation lighting, automotive headlamps, advertising, general lighting, traffic signals, camera flashes, lighted wallpaper and medical devices.

Unlike a laser, the color of light emitted from an LED is neither coherent nor monochromatic, but the spectrum is narrow with respect to human vision, and functionally monochromatic.

The energy efficiency of electric lighting has increased radically since the first demonstration of arc lamps and the incandescent light bulb of the 19th century. Modern electric light sources come in a profusion of types and sizes adapted to many applications. Most modern electric lighting is powered by centrally generated electric power, but lighting may also be powered by mobile or standby electric generators or battery systems. Battery-powered light is often reserved for when and where stationary lights fail, often in the form of flashlights, electric lanterns, and in vehicles.

Although lighting devices are widely used, there are still lots of opportunity and benefit to improve the lighting devices to provide more convenient, low cost, reliable and beautiful lighting devices for enhancing human life.

### SUMMARY

A smart lighting apparatus has a metal cover, an antenna module, a wireless circuit, a cup body, a light source, and a driver. It was a German physicist Heinrich Hertz that built the first antennas. He built the antennas in his pioneering experiment. An antenna is used to be a kind of interface between radio waves. Those radio waves move in metal conductors in the form of electric currents. Also, the antenna is electrically connected to the receiver or transmitter. When transmitting, radio transmitter provides the antenna's terminal with an electric current. After that, the antenna may radiate the energy which comes from the electric current as radio waves. After transmission, it's time for reception. In reception, a receiver amplifies the electric current produced by the power of a radio wave intercepted by an antenna. An antenna may have some components that are not connected to the transmitter. Those components include parabolic reflectors, horns, or parasitic elements. Those components are used to turn the radio waves into a beam or other radiation patterns that you want.

Parasitic element is a circuit element. But most of the time, the element is not wanted to have for a device's intended purpose. Take resistor for example. A resistor is for offering resistance. At the same time, however, it also has parasitic capacitance which is unwanted. Parasitic elements are inevitable, but component designer will do their best to use less parasitic elements.

And “wireless” is a way of communication. The wireless communication is used to transfer information or power between points. Most important of all, the points are not connected by electrical conductors. This kind of technologies use radio waves mentioned above. Radio waves may go for a long distance even for millions of kilometers. In other words, wireless technology offers the opportunity of long-range communications. The wireless technology is applied to a lot of applications, like wireless networking, personal digital assistants, wireless computer mouse, broadcast television, and GPS units.

The metal cover has a central opening, a front side and a back side. The antenna module has an antenna area. The antenna area appears on an exterior surface of the front side of the metal ring. The wireless circuit is electrically connected to the antenna module. The antenna module receives a wireless signal from the antenna area. When something is electrically connected, it needs electrical connector. Electrical connector is a device to bring electrical terminations together and make an electrical circuit. And an electrical circuit is a network that is composed of a closed loop. The electrical circuit offers a return path for the electrical current.

The cup body has a container and a cup rim. The cup rim of the cup body is coupled with the internal opening. The light source is disposed in the container. The light source includes multiple LED modules. LED's full name is light-emitting diode. LED is a semiconductor light source. When current flows through the semiconductor light source, the semiconductor light source emits light. There is one thing in the semiconductor. And that is called electrons. After the electrons recombine with electron holes, the electrons release energy in the form of photons. The energy of the photons decides the color of the light. In the past, LEDs were used to replace small incandescent bulbs. Recently, there is a high-output white light LEDs. And this kind of high-output white light LEDs are suitable for room and outdoor area lighting. Compared with the incandescent light sources, LEDs consume less energy, have longer lifetime, smaller size, and better physical robustness. Other than room and outdoor lighting, LEDs are also used in advertising, traffic signals, medical devices, and automotive headlamps. The automotive headlamps are for lighting and signaling. The automotive headlamps are on the motor vehicles. The headlamps help the pedestrians to notice the vehicles' presence. And those emergency vehicles also have the automotive headlamps to warn drivers and make them go first.

The multiple LED modules mentioned in the last paragraph emit a light through the internal opening. The driver converts an external power source to a driving current to the light source. A driver is a circuit or component. The driver is for having control over another circuit or component. Usually, driver has at least two functions. First is to regulate current flowing through a circuit. Second is to control other factors. The factors include other components and devices in the circuit.

Then the driver is electrically connected to the wireless circuit. And the light source mentioned in the last paragraph generates heat. Afterwards, the heat is transmitted to the metal cover. The driver is operated according to the wireless signal from the wireless circuit.

In some embodiments, the smart lighting apparatus has the antenna. The antenna is integrated with the metal cover as a module.

In some embodiments, the smart lighting apparatus has an electrode on the back side of the metal cover. The metal cover transmits the wireless signal to the wireless circuit. The electrode is an electrical conductor. In a circuit, the electrode is for making contact with a nonmetallic part. And the nonmetallic part may include a semiconductor, a vacuum of air, or an electrolyte. The semiconductor passes current more easily in one direction than the other. In order to do this, the material of the semiconductor must have an electrical conductivity value which falls between that of a conductor and that of an insulator. A conductor is like cooper, silver, or gold. An insulator is like glass. One of the semiconductor's feature is that when its temperature goes up, its resistance goes down, which is opposite to the feature of a metal. Silicon is one of the examples of semiconductors. Other than silicon, gallium arsenide is a semiconductor as well.

In some embodiments, the antenna module has a ground electrode insulated from the antenna area.

In some embodiments, the antenna area mentioned in the last paragraph is electrically insulated from the metal cover.

In some embodiments, a top surface of the antenna area and the exterior surface of the front side are on the same plane.

In some embodiments, the exterior surface of the front side and the antenna area are covered with a same non-metallic layer. In chemistry, non-metal is a chemical element. The element mostly doesn't have the characteristics that metal has. When non-metal has chemical reaction with other elements, they get or share electrons with them. While in physics, a non-metal fails to have high melting point, density, and boiling point. Aside from that, a non-metal is generally delicate and fragile. There are generally seventeen elements classified as non-metals. Most of the elements are gases. Those gases include oxygen, neon, radon, hydrogen, krypton, chlorine, helium, xenon, nitrogen, and fluorine. One of the elements is bromine, which is a kind of liquid. Some of the elements are solids. And those solid elements include carbon, sulfur, iodine, selenium, and phosphorus.

In some embodiments, the metal cover has an antenna container on the back side of the metal cover. The antenna container places the antenna module and extends the antenna area to appear from a slit on the front side of the metal cover. Slit is a narrow cut or opening in something.

In some embodiments, the antenna module has an elastic inverse hook structure. A hook is a tool that is composed of a length of material. The material is usually metal. A part of the hook is curved and indented. This curved part of the hook is used for grabbing onto, connect, or attach itself onto another object. Other than that, in order to pierce another thing to attach itself by the curved part, one of some hook's ends is designed to be pointed. This kind of design is applied to ear hook, fish hook, or meat hook. The elastic inverse hook structure mentioned above is plugged in a corresponding plugging structure. In addition, the elastic inverse hook structure is fixed to the metal cover after the antenna module is plugged in the metal cover.

In some embodiments, there is a slit on the metal cover. Aside from that, the antenna area is disposed within the slit. The antenna is also electrically insulated from the metal cover.

In some embodiments, the slit is a through hole on the metal cover. A through hole is a hole which utterly goes through an object. And the opposite of a through hole is a blind hole. Blind hole is a hole that is drilled into an object to a certain depth. The difference between a blind hole and a through hole is that while drilling a blind hole, people don't break through to the other side of the object. Thus, there won't be hole on the other side. In other words, a blind hole is a hole that cannot ho all the way through something, but a through hole is a hole that can.

In some embodiments, the slit is a semi-through hole on the metal cover.

In some embodiments, the slit has an arc shape.

In some embodiments, there are multiple slits. The slits place multiple antenna areas corresponding to different wireless frequencies. In our daily life, “frequency” means how often a thing, activity, or event repeat itself over a set amount of time. And in physics, the frequency of a wave is the number of how many wave crests pass a point in a second. So, in other words, the frequency of a wave is also the number of how many troughs pass a point in a second. The wave crest means a point with the greatest positive value on a wave. And the opposite of a crest is a trough. The unit of frequency is Hertz. Hertz is named after a German physicist whose name is Heinrich Rudolf Hertz. Heinrich Rudolf Hertz is also the one that built the first antenna, which is mentioned above already.

In some embodiments, the length of the antenna is between 55 mm to 70 mm.

In some embodiments, the length of the antenna is between 20 mm to 40 mm.

In some embodiments, the cup body has a passing hole. And the antenna module is electrically connected to the driver via the passing hole.

In some embodiments, the antenna area is placed aside the internal opening.

In some embodiments, the antenna area is placed between the cup rim and the metal cup.

In some embodiments, there is a plastic ring. The plastic ring is disposed between the cup rim and the metal cup. And the antenna area is covered by the plastic ring.

In some embodiments, a capacitor input matching plate is used for exercising signal receiving and transmission of the antenna in a slit antenna disposed on an exterior surface of a metal housing a lighting apparatus.

The slit antenna is integrated with the metal housing, e.g. used in an UFO light, a downlight, a light tube, for preventing the metal housing to affect signal quality on receiving and transmission of wireless signals.

The capacitor input matching plate may be made of a rigid PCB (Printed Circuit Board) or a flexible printed circuit board added with plastic housing.

The assembly processing is simple, thus decreasing manufacturing cost. In addition, such design may be made as a module. Specifically, the antenna may include a capacitor input matching plate and related circuit as an antenna module. The antenna module is attached to an inner wall of a metal housing of lighting apparatus, corresponding to an antenna slit disposed on an external surface of the metal housing.

In some embodiments, fire-proof capability is critical and therefore a metal housing is adopted. For example, when a light source has high operation power consumption.

In some embodiments, a part of a metal housing of a lighting apparatus has a slit. The slit has a first elongated edge and a second elongated edge of the slit.

There is also a capacitor input matching portion with a first input matching plate and a second input matching plate. The first matching part and the second matching part form a slit section. The slit section has two elongated edge substantially aligning the first elongated edge and the second elongated edge.

There is a signal activation source with a signal terminal and a ground terminal. The signal terminal is electrically connected to the first input matching plate and the ground terminal is electrically connected to the second input part.

In some embodiments, the slit of the metal housing is a half wave-length slot antenna.

In some embodiments, the slit of the metal housing is a quarter wave-length mono-pole slot antenna.

In some embodiments, the metal part is arc shape or a plain shape structure.

In some embodiments, the first input matching plate and the second input matching plate are electrically connected.

In some embodiments, the first input matching plate and the second input matching plate are two separate objects.

In some embodiments, the first input matching plate and the second matching part are formed at different plane of a single plane or a curve plane.

In some embodiments, the first input matching and the second matching part are polygonal shapes.

In some embodiments, the metal part and the capacitor input matching plate are separately formed on opposite sides of a printed circuit board.

In some embodiments, the capacitor input matching plate is formed on a plastic housing as a module.

In some embodiments, the slit of the metal housing is a polygonal shape.

### BRIEF DESCRIPTION OF DRAWINGS

FIG. 1 is an exploded perspective view of a smart lighting apparatus.

FIG. 2 is a schematic view of an antenna module of the smart lighting apparatus.

FIG. 3 is a back view of the antenna module illustrated by FIG. 2.

FIG. 4 is another schematic view of an antenna module of a smart lighting apparatus.

FIG. 5 is another schematic view of an antenna module of a smart lighting apparatus.

FIG. 6 is a structural view of an antenna module.

FIG. 7 is an exploded diagram of an example of a capacitor input matching part.

FIG. 8 shows a top view of the example in FIG. 7.

FIG. 9 shows an example, where a capacitor input matching part is attached to a metal housing of a lighting apparatus.

### DETAILED DESCRIPTION

In an embodiment, a lighting apparatus includes an antenna module. The antenna module is for tackling with the technical problems of the conventional antenna which needs to be kept away from metal shielding. The antenna module includes a metal piece, one or more slits, a signal input point, and a short circuit point.

On the metal piece may be one or more than one slits. On two sides of the slits may be signal input point and short circuit point respectively.

In one embodiment, the slits mentioned above may be a straight line, fold line, arc, multiple random arcs connected to each other, or at least one random straight line and at least one random fold line connected to each other.

In one embodiment, every slit mentioned above has the same width. The width mentioned above is 0.8˜3 mm.

In one embodiment, the widths of the slits mentioned above may increase gradually along a direction.

In one embodiment, the lengths of the slits mentioned above may be different.

In one embodiment, the slits mentioned above may be a closed through hole or an open form.

The light apparatus includes a smart lighting apparatus. The smart lighting apparatus includes a metal housing, a light source plate, a RF transceiver module, and a signal input module. The metal housing includes the antenna module. The light source plate may be formed in the metal housing. The RF transceiver module includes a signal output.

The signal input module includes a signal input portion. The signal input portion mentioned earlier connected between the signal input point and the signal output.

In one embodiment, the metal housing mentioned above includes a base and a metal rim. The slits mentioned above appear on the metal rim.

In one embodiment, the signal input module includes a ground surface. The ground surface mentioned above is connected to the short circuit point of the antenna module mentioned above.

In one embodiment, the RF transceiver module mentioned above is a radio frequency signal source. The radio frequency signal source passes through a coaxial line and connect to the antenna module.

The antenna module includes metal piece and the one or more slits appeared on the metal piece. The slits have signal input point and short circuit point respectively on two sides of the slits. The antenna module is integrated on the metal piece in the form of slits.

The antenna module can use any metal housing that needs antenna module as metal piece. The antenna module may be used in various applications. This may be applicable to the electrical products with metal housing and antenna-related products.

The antenna module transmits and receives signals better and has higher integrity. The antenna module with slits doesn't have protruding design. This design may avoid the problem of antenna blocking the light and limitation of design effectively. In addition, the antenna module is formed with the slits on the metal piece.

The slits mentioned above may be a straight line, fold line, arc, multiple random arcs connected to each other, or at least one random straight line and at least one random fold line connected to each other, which can increase the flexibility of the slit design.

The design can maintain the function and beauty of the antenna module and decrease the volume of products.

In order to explain the technical proposal of this device, the following is the detailed description of the lighting apparatus with some figures and embodiments.

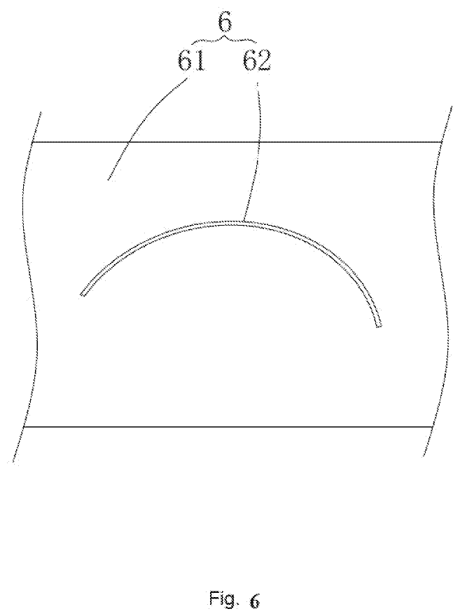

Please refer to FIG. 6. First, the lighting apparatus includes a kind of antenna module 6.

The antenna module includes a metal piece 61 and the one or more than one slits 62 appeared on the metal piece 61.

The slit 62 has a signal input point and a short circuit point respectively on two sides of the slit. The signal input point inputs radio frequency signal to the antenna module. The short circuit point helps the antenna module 6 get grounded.

The width of the slit 62 is 0.8˜3 mm. Within this range, the wider the width is, the better the radiation performance of the antenna is. The lighting apparatus includes an antenna module 6. The antenna module 6 includes a metal piece 61 and the one or more than one slits 62 appeared on the metal piece.

The slit 62 has a signal input point and short circuit point respectively on two sides of the slit 62. The antenna module is integrated on the metal piece in the form of slit.

The antenna module may use any metal housing that needs antenna module as metal piece. The antenna module may be used in various applications. And the antenna module transmits and receives signals better and has higher integrity.

Also, the antenna module with slit doesn't have protruding design. This design may avoid the problem of antenna blocking the light and limitation of design effectively.

In addition, the antenna module is formed with the slit on the metal piece, which may increase the flexibility of the slit design.

The design can maintain the function and beauty of the antenna module and decrease the volume of product. The antenna module 6 is applicable to any electrical antenna-related products.

The following is the specific description of the features of the antenna module and the integration of the antenna module in the smart lighting apparatus with the help of some embodiments of the smart lighting apparatus.

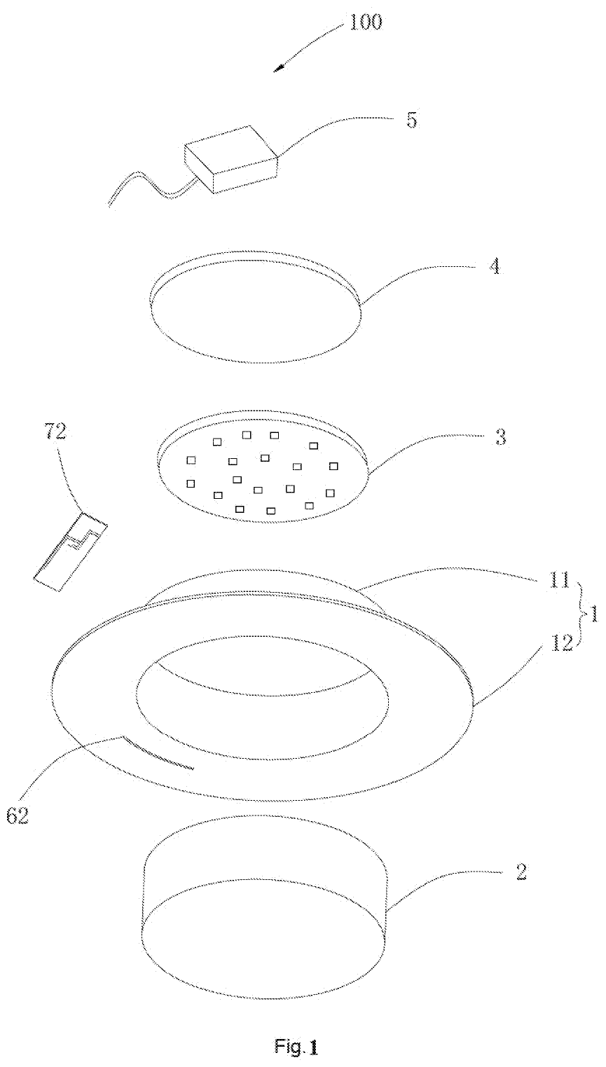

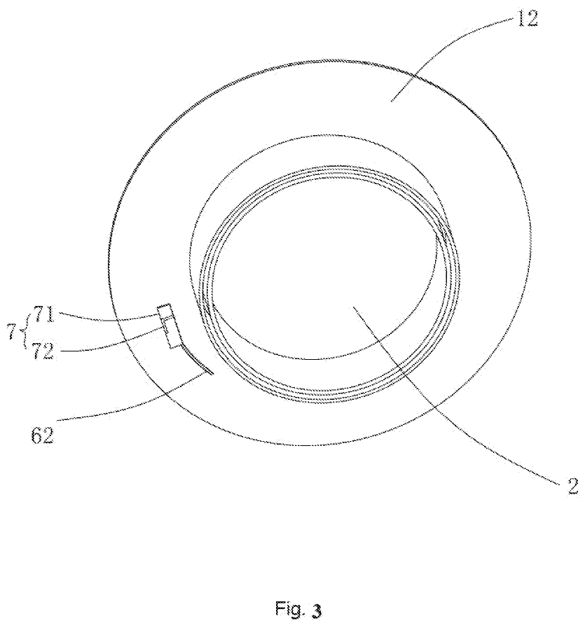

Please refer to FIG. 1 and FIG. 3.

The lighting apparatus includes a smart lighting apparatus 100. The smart lighting apparatus has a metal housing 1, a light source plate 3, a cup housing 2, a reflective board 4, a RF transceiver module (not shown), and a signal input module 7.

The light source plate 3 is in a container made of the metal housing 1, the cup housing 2, and the reflective board 4. The RF transceiver module and the signal input module 7 are on the exterior surface of the metal housing 1. On the metal housing 1 may be one or more than one slits 62.

Therefore, the metal housing 1 in the smart light 100 or a part of the metal housing 1 are used as a metal piece of the antenna module 6.

The metal housing 1 with slit 62 is used as the antenna module as well. The two sides of the slit 62 have signal input point (not shown) and short circuit point (not shown) respectively. The signal input module 7 includes a circuit board 71, a signal input portion, and a ground surface (not shown).

The signal input portion 72 and the ground surface are on the circuit board 71 and not connected to each other. Then, the signal input portion 72 is connected to the signal input point on one side of slit 62.

The short circuit point on the other side of the slit 62 is connected to the ground surface. Signal interference may be reduced by connecting the short circuit point to the ground surface.

The RF transceiver module includes a signal output (not shown). The signal output is connected to the signal input point on one side of slit 62, which is used to provide the antenna module with RF signal.

The smart lighting apparatus includes a metal housing 1, a RF transceiver module, and a signal input module. On the metal housing 1 are one or more than one slits 62.

The metal housing 1 with the slit 62 mentioned above form the antenna module. The RF transceiver module and the signal input module 7 provide the antenna module with radio frequency signal. The antenna module is integrated on the metal housing 1 of the smart lighting apparatus 100.

The antenna module transmits and receives signal better. The integrity of antenna module and the smart lighting apparatus 100 is higher, which may reduce the volume of the product. And the slit does not have protruding design. This design may avoid the problem of antenna blocking the light and limitation of design effectively.

In addition, the antenna module is formed by the slit 62 on the metal housing 1, which can increase the flexibility of the slit 62 design. The design can maintain the function and beauty of the antenna.

Also, the design of the slit is applicable to the electrical products with metal housing 1 and antenna-related products. The antenna module may be used in various applications.

Please refer to FIG. 1. The metal housing 1 includes a base 11 and a metal rim 12. The base is used to form the circular side of the container.

The metal rim 12 is connected to edge of the base 11 and diffuses outward. The slit 62 are on the metal rim 62. The front end of the base 11 includes a cup housing 2.

The back end of the base 11 includes a reflective board 4. The cup housing 2, the reflective board 4, and the base 11 form a container. The light source plate 3 is between the reflective board 4 and the cup housing 2. Behind the light source plate 3 may be a power source 5.

The power source 5 may be used to provide the light-emitting component on the light source plate 3 with driving current. The smart lighting apparatus may have a housing (not shown). The housing may cover the power source 5 behind the light source plate 3 and the base 11.

The slit 62 is on the metal rim 12. The RF transceiver module and the signal input module 7 are on back side of the metal rim 12. In other words, they are on the side of the surface that faces the light source plate 3.

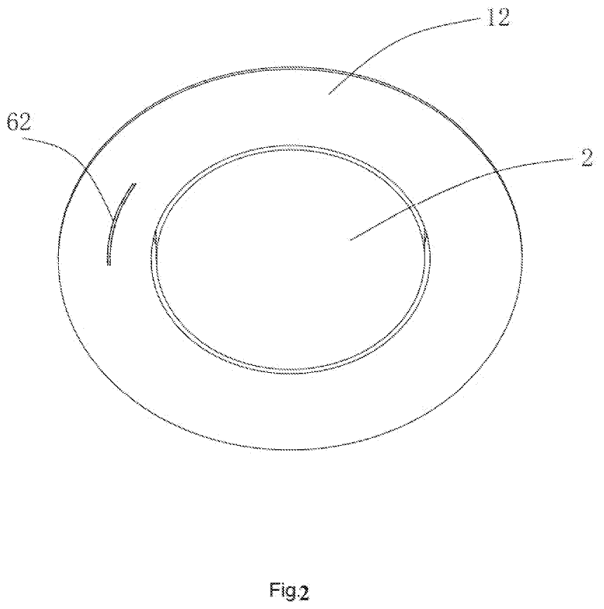

The slit 62 may be a closed form or an open form. In the examples of FIG. 2 to FIG. 5, one or more slits 62 of closed form are illustrated, when the peripheral edge of the slit 62 is within the metal rim 12. In another case, the slit 62 of the open form may extend to an exterior edge of the metal rim 12.

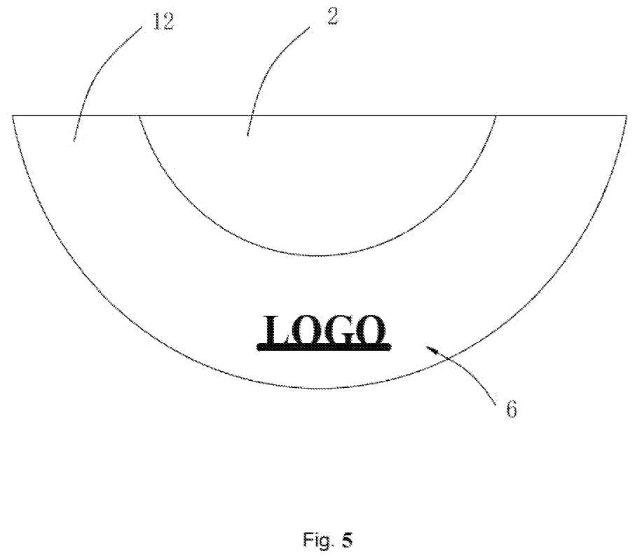

The slit 62 may be a straight line, fold line, arc, multiple random arcs connected to each other, or at least one random straight line and at least one random fold line connected to each other, which may form a specific pattern in the example of FIG. 5.

In one embodiment, the slit 62 may be designed to be any kind of logo pattern. The length of the slit 62 mentioned below means the full length of the arc slit 62.

The length decides which signal frequency is applicable. The length of the closed through-hole slit 62 is half of the wavelength of the selected signal frequency. The length of the open form slit 62 is a quarter of the wavelength of the selected signal frequency.

For example, if the signal frequency is 2.5 GHz and the wavelength is 125 mm, the length of the closed through-hole slit 62 may be designed to be 62.5 mm and the length of the open form slit 62 is 31.25 mm. A slit 62 corresponds to an operable signal frequency.

The length of the slits 62 of this device may differ in order to match multiple operable signal frequencies.

Take the closed through hole as example. If the length of the slit 62 is 62.5 mm, the corresponding antenna module may be operated in 2.4 GHz. If the length of another slit 62 is 3. mm, the corresponding antenna module may be operated in 5 GHz.

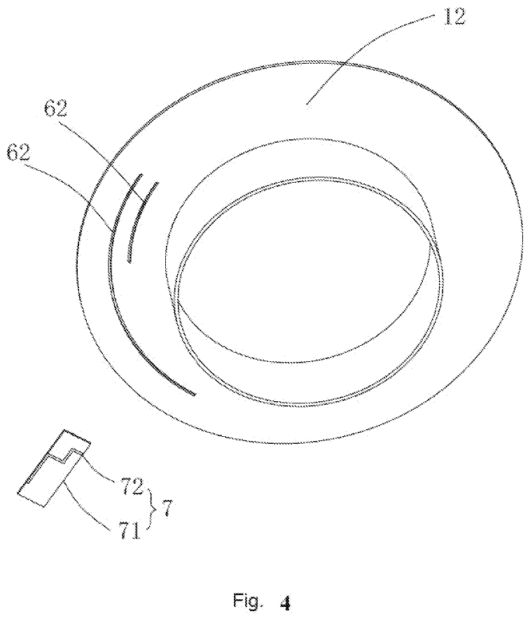

Therefore, there may be multiple frequency bands operations in the example of FIG. 4. Along the direction that the length of the slit 62 goes, the width of the slit 62 may be the same and in a regular shape of a strip. Or the width of the slit 62 may become wider gradually and in a shape of a horn.

In one embodiment, the size of the metal rim 12 integrated in the smart lighting apparatus 100 and the width of the slit 62 are 1 mm in the examples of FIG. 2 to FIG. 4.

The RF transceiver module may be a radio frequency signal source. The radio frequency signal source passes through the coaxial line and connects to the antenna module. Specifically, the radio frequency signal source passes through the coaxial line and connects to the signal input portion 72.

Then, the radio frequency signal source passes through the signal input portion 72 to input the radio frequency signal to the antenna module. The signal input portion 72 may be in random shape.

In the examples of FIG. 3 and FIG. 4, the signal input portion is in the shape of multiple L connected to each other. Or the shape may be a polygon with arc shape and different widths. One end of the signal input portion 72 is connected to the radio frequency signal output of the RF transceiver module.

After the other end crossed the slit 62, it may electrically connect to the metal rim 12. In other words, it electrically connects to the signal input point on one side of the slit.

If the smart lighting apparatus has a slit 62, the other end of the signal input portion 72 is electrically connected to the signal input point directly. If the smart lighting apparatus has multiple slits 62, the other end of the signal input portion 72 diverges into multiple connecting ends. Every connecting end is electrically connected to the signal input point on one side of a slit 62.

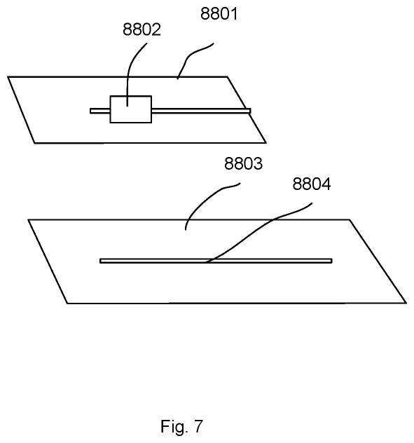

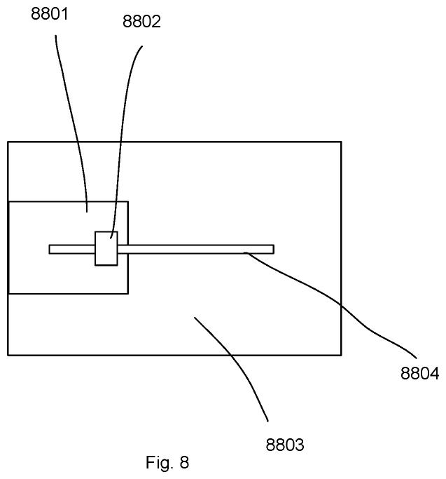

Please refer to FIG. 7 and FIG. 8. A capacitor input matching plate is used for exercising signal receiving and transmission of the antenna in a slit antenna disposed on an exterior surface of a metal housing a lighting apparatus. There is a signal activation source 8802. The signal is sent to the capacitor input matching plate 8801. There is a slit antenna 8804 on a metal housing 8803 responding to the capacitor input matching plate 8801.

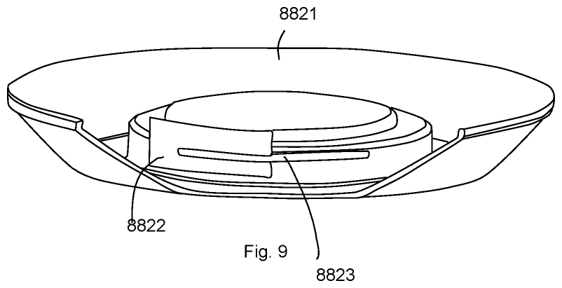

Please refer to FIG. 9. In FIG. 9, a lighting apparatus has a metal rim 8821. There is a slit 8823 formed on an exterior side of the metal rim 8821. There is a capacitor input matching plate 8822 attached to the metal rim 8821.

The slit antenna is integrated with the metal housing, e.g. used in an UFO light, a downlight, a light tube, for preventing the metal housing to affect signal quality on receiving and transmission of wireless signals.

The capacitor input matching plate may be made of a rigid PCB (Printed Circuit Board) or a flexible printed circuit board added with plastic housing.

The assembly processing is simple, thus decreasing manufacturing cost. In addition, such design may be made as a module. Specifically, the antenna may include a capacitor input matching plate and related circuit as an antenna module. The antenna module is attached to an inner wall of a metal housing of lighting apparatus, corresponding to an antenna slit disposed on an external surface of the metal housing.

In some embodiments, fire-proof capability is critical and therefore a metal housing is adopted. For example, when a light source has high operation power consumption.

In some embodiments, a part of a metal housing of a lighting apparatus has a slit. The slit has a first elongated edge and a second elongated edge of the slit.

There is also a capacitor input matching portion with a first input matching plate and a second input matching plate. The first matching part and the second matching part form a slit section. The slit section has two elongated edge substantially aligning the first elongated edge and the second elongated edge.

There is a signal activation source with a signal terminal and a ground terminal. The signal terminal is electrically connected to the first input matching plate and the ground terminal is electrically connected to the second input part.

In some embodiments, the slit of the metal housing is a half wave-length slot antenna.

In some embodiments, the slit of the metal housing is a quarter wave-length mono-pole slot antenna.

In some embodiments, the metal part is arc shape or a plain shape structure.

In some embodiments, the first input matching plate and the second input matching plate are electrically connected.

In some embodiments, the first input matching plate and the second input matching plate are two separate objects.

In some embodiments, the first input matching plate and the second matching part are formed at different plane of a single plane or a curve plane.

In some embodiments, the first input matching and the second matching part are polygonal shapes.

In some embodiments, the metal part and the capacitor input matching plate are separately formed on opposite sides of a printed circuit board.

In some embodiments, the capacitor input matching plate is formed on a plastic housing as a module.

In some embodiments, the slit of the metal housing is a polygonal shape.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A smart lighting apparatus, comprising:
a metal ring with a central opening, a front side and a back side;
an antenna module with an antenna area appeared on an exterior surface of the front side of the metal ring, the antenna module having a capacitor input matching plate;
a wireless circuit, electrically connected to the antenna module for receiving a wireless signal from the antenna area;
a cup body with a container and a cup rim, the cup rim of the cup body being coupled with the internal opening;
a light source disposed in the container, the light source comprising multiple LED modules emitting a light through the internal opening; and
a driver for converting an external power source to a driving current to the light source and electrically connected to the wireless circuit, heat generated by the light source being transmitted to the metal ring, the driver being operated according to the wireless signal from the wireless circuit.

2. The smart lighting apparatus of claim 1, wherein the capacitor input matching plate is a module attached to the metal ring.

3. The smart lighting apparatus of claim 2, wherein there is an electrode on the back side of the metal ring for transmitting the wireless signal to the wireless circuit.

4. The smart lighting apparatus of claim 2, wherein the antenna module has a ground electrode insulated from the antenna area.

5. The smart lighting apparatus of claim 2, wherein the antenna area is electrically insulated from the metal ring.

6. The smart lighting apparatus of claim 1, wherein a top surface of the antenna area and the exterior surface of the front side are on the same plane.

7. The smart lighting apparatus of claim 6, wherein the exterior surface of the front side and the antenna area are covered with a same non-metallic layer.

8. The smart lighting apparatus of claim 1, wherein the metal ring has an antenna container on the back side of the metal ring for placing the antenna module and extending the antenna area to appear from a slit on the front side of the metal ring.

9. The smart lighting apparatus of claim 8, wherein the antenna module has an elastic inverse hook structure to be plugged in a corresponding plugging structure and fixed to the metal ring after the antenna module is plugged in the metal ring.

10. The smart lighting apparatus of claim 1, wherein there is a slit on the metal ring, the antenna area is disposed within the slit and electrically insulated from the metal ring.

11. The smart lighting apparatus of claim 10, wherein the slit is a through hole on the metal ring.

12. The smart lighting apparatus of claim 10, wherein the slit is a semi-through hole on the metal ring.

13. The smart lighting apparatus of claim 10, wherein the slit has an arc shape.

14. The smart lighting apparatus of claim 10, wherein there are multiple slits for placing multiple antenna areas corresponding to different wireless frequencies.

15. The smart lighting apparatus of claim 14, wherein the antenna length is between 55 mm to 70 mm.

16. The smart lighting apparatus of claim 14, wherein the antenna length is between 20 mm to 40 mm.

17. The smart lighting apparatus of claim 1, wherein the cup body has a passing hole, the antenna module is electrically connected to the driver via the passing hole.

18. The smart lighting apparatus of claim 1, wherein the antenna area is placed aside the internal opening.

19. The smart lighting apparatus of claim 18, wherein the antenna area is placed between the cup rim and the metal cup.

20. The smart lighting apparatus of claim 18, wherein there is a plastic ring disposed between the cup rim and the metal cup, the antenna area is covered by the plastic ring.
